(19) United States
(12) Patent Application Publication
(10) Pub. No.: US 2025/0078847 A1
(43) Pub. Date: Mar. 6, 2025

(54) System and Method for Generating a Unique Identity for a Musical Composition

(71) Applicants: Christina Spirou, Oakville (CA); David Ormonde, Mississauga (CA); Dimitrios Spirou, Oakville (CA)

(72) Inventors: Christina Spirou, Oakville (CA); David Ormonde, Mississauga (CA); Dimitrios Spirou, Oakville (CA)

(21) Appl. No.: 18/457,492

(22) Filed: Aug. 29, 2023

(51) Int. Cl. G10L 19/02; G10L 19/008

(52) U.S. Cl. CPC G10L 19/0204; G10L 19/008

(57) ABSTRACT

A system and method for generating mathematical representations of a musical composition, identifying the degree of similarity based on the sum of the musical compositional distinct components, and establishing a compositional lineage. The system includes an electronic device with a Fast Fourier Transform (FFT) engine implemented using Python code. The method involves processing a musical composition and its corresponding stems to convert them into unique mathematical representations using FFTs. The resulting mathematical representations serve various purposes such as verifying the inclusion of stems within the master composition, identifying the existence of stems within sample compositions, and quantifying the degree of similarity between identified stems.

### BACKGROUND OF THE INVENTION

The present invention relates to a system and method for generating mathematical representations of a musical composition, identifying the degree of similarity based on the sum of the musical compositional distinct components, and establishing a compositional lineage. More specifically, the system and method processes a WAV file (Waveform Audio File Format) of a musical composition and its corresponding stems, also in the form of .wav or .wave files, as input to a coded script that converts the .wav files into their mathematical representations, in the form of Fast Fourier Transforms (FFTs). FFTs convert the input signal into individual spectral components, characterizing the frequency information into a unique mathematical equation. These resulting FFTs are unique to the originating .wav files, providing a mathematical basis for further analysis.

In the digital era, the music industry faces a dilemma caused by an overwhelming abundance of choices due to the emergence of digital media. Due to the abundance of music and ease of sharing music on a variety of online platforms, users are now confronted with an ever-expanding pool of media that surpasses their capacity for consumption. Traditional methods of media discovery, like searching by artist, album, or title, are no longer sufficient to address this problem. Users are limited to what they already know, while the vast reservoir of available content remains largely unexplored. Consequently, there is an urgent need for innovative methods that improve the objectivity and efficiency of identifying similar musical works. These methods can enable users to explore new music that aligns with their preferences while also providing valuable assistance in potentially identifying instances of alleged copyright infringement.

There are several tools available to copyright holders to identify audio and video works to aid in the identification of possible infringement. These include some content recognition technologies that can analyze and compare audio signatures or unique digital marks embedded in copyrighted works. These technologies identify instances of potential infringement by matching audio samples or watermarks against a database of known copyrighted material. Other technologies include content indexing which require a comprehensive database of copyrighted works and algorithms to scan and analyze digital content across the internet. These algorithms may employ techniques such as audio fingerprinting, digital watermark matching, or textual analysis to identify matches or similarities. However, these algorithms are typically limited to sampling certain audio files, such as MP3 files. MP3 files are compressed and suitable for efficient storage and transmission over the internet. On the other hand, WAV files are uncompressed audio files that preserve the original audio data in its entirety.

Additionally, copyright holders may use a continuous monitoring service typically providing ongoing monitoring to identify new instances of potential infringement as they emerge. This involves regularly updating the copyrighted work database, refining comparison algorithms, and continuously scanning online platforms for new content. These services can detect potential infringements by searching for matches or similarities between copyrighted works and online content, including music tracks, videos, and textual content. However, the process of determining the degree of similarity between two songs or compositions ultimately relies heavily on subjective opinions, which hampers efficient and objective analysis. This limitation poses challenges for music enthusiasts seeking to explore similar works and for copyright holders who aim to identify potential infringements.

Therefore, there is a need for a method that enhances the objectivity and efficiency of the musical comparison process, enabling accurate assessment of similarity for the purposes of discovering similar works and potentially detecting alleged copyright infringement.

In light of the devices disclosed in the known art, it is submitted that the present invention substantially diverges in design elements and methods from the known art and consequently it is clear that there is a need in the art for an improvement for an objective and efficient process to generate a unique identity for musical composition and its stems, for use as means of accurate assessment of similarity of comparative works on mathematical bases. In this regard, the instant invention substantially fulfills these needs.

### SUMMARY OF THE INVENTION

In view of the foregoing disadvantages inherent in the known types of composition recognition systems, the present invention provides a new system and method for generating a unique identity for a musical composition. The method for generating a unique identity for a musical composition comprises generating a unique identity for a musical composition and its corresponding components (stems) using mathematical representations. The method also includes the steps of processing a master audio file associated with a musical composition to generate a mathematical representation in the form of an audio file FFT. The method further involves verifying the inclusion of the master stems within the composition by associating each master stem FFT within the master FFT. Additionally, the system and associated method quantifies the degree of similarity between two stems from different compositions by comparing the coefficients of the stem FFTs.

It is an objective of the present invention to provide an embodiment of the system comprising an electronic device having a processor, a memory, and an FFT engine. The FFT engine is designed to execute the logic required for processing the audio file and generating the mathematical representations. It utilizes Python code, which provides a flexible and efficient programming language for audio processing and FFT computations. The electronic device also includes input/output interfaces for receiving the audio file and communicating the results of the method. The electronic device may be in communication with a network of other devices, such as a server, to complete the analysis.

It is an objective of the present invention to provide an embodiment of the system to generate a unique mathematical representation for a musical composition based on the sum of its distinct components (stems) using mathematical techniques, such as Fast Fourier Transforms (FFTs), ensuring a reliable and consistent identification method.

It is yet another objective of the present invention to provide an embodiment of the system to verify the inclusion of corresponding stems within the whole musical composition, enabling a robust means of validating creative ownership and compositional integrity. Moreover, the system can enable the verification of the existence of a composition or its stems within a separate composition, facilitating the identification of potential copyright infringements or similarities between different musical works.

It is an objective of the present invention to provide an embodiment of the system to quantify the degree of similarity between two identified stems using their mathematical representations, providing an objective and efficient method for comparing musical components for potential copyright infringement analysis.

It is yet another objective of the present invention to provide an embodiment of the system to utilize Python applied to WAV files, ensuring the integrity of the audio data without compression, as opposed to MP3 files, which can lose valuable information during the compression process.

It is an objective of the present invention to provide an embodiment of the system to apply common musical distortions in music production to stems and generate their corresponding FFTs to serve as a reference set, enhancing the accuracy of similarity calculations and identifying potential infringement cases more effectively.

It is an objective of the present invention to provide an embodiment of the system to establish compositional lineage by analyzing the prevalence of individual stems across multiple compositions using their mathematical representations, providing insights into the origins and influences of musical works.

It is another objective of the present invention to provide another embodiment of the system to support music recommendation systems by offering an objective and data-driven approach to identify similar musical works.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram of a FFT of an audio file with each stem identified in accordance with one embodiment of the present invention.

FIG. 2 shows a diagram of verification of the master stem FFTs of the master audio file and identification of the degree of similarity of each of the master stem FFT with a sample stem FFT in accordance with one embodiment of the present invention.

FIG. 3 shows a diagram of a comparison of the FFT of the master stems with a FFT of the sample stems in accordance with one embodiment of the present invention.

### DETAILED DESCRIPTION OF THE INVENTION

Reference is made herein to the attached drawings. Like reference numerals are used throughout the drawings to depict like or similar elements of the system. For the purpose of presenting a brief and clear description of the present invention, the embodiment discussed will be used for generating mathematical representations of a musical composition, identifying the degree of similarity based on the sum of the musical compositional distinct components, and establishing a compositional lineage. The figures are intended for representative purposes only and should not be considered to be limiting in any respect. Furthermore, the described features, structures, or characteristics may be combined in any suitable manner in one or more embodiments. In the following description, numerous specific details are provided to give a thorough understanding of embodiments.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment,” “first embodiment”, “second embodiment”, or “third embodiment” does not necessarily refer to the same embodiment.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry. As used herein “master” refers to a reference audio file and “master FFT” refers to a mathematical representation of the master. “Master stem” refers to a component of the master that isolates a specific instrument or group of instruments from the rest of the mix. Stems are created by separating different elements of a song's arrangement into individual audio tracks. Therefore, “master stem FFT” refers to the mathematical representation of the master stem. “Sample” refers to the target musical composition and “sample stem” refers to the stems of the sample. “Sample stem FFT” refers to the mathematical representation of the sample stem.

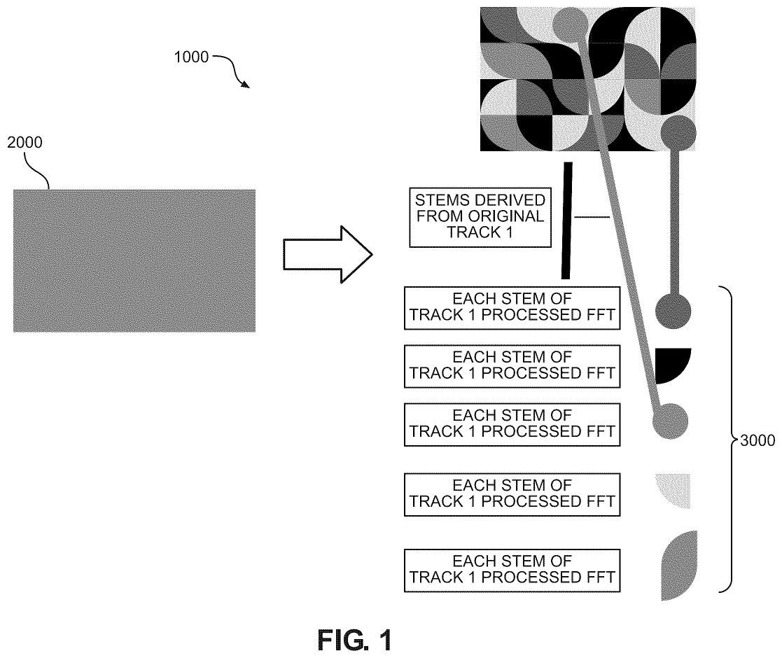

Referring now to FIG. 1, there is shown a diagram of a Fast Fourier Transform (FFT) transformation of an audio file with each stem identified in accordance with one embodiment of the present invention. In one embodiment, the system and method provide steps to generate a unique identity for a musical composition and its corresponding components, also known as “stems,” using mathematical representations. Each stem from the original musical composition, also known as a master, is configured to be used for comparative analysis with stems from other compositions which results in a quantification of the degree of similarity between the two stems. “Stems” refer to the sine and cosine waves generated during the (FFT) process, which are the building blocks for representing the frequency components of the audio signal.

The system and method utilize a Fast Fourier Transform (FFT) to create a mathematical expression/representation of each stem and later to determine the degree of similarity between two stems (the master stem and the sample stem) by an analysis of the coefficients of the FFT expressions. The Fast Fourier Transform (FFT) is a mathematical algorithm used to transform a time-domain signal into its frequency-domain representation. As known to those skilled in the art, the fast Fourier Transform (FFT) is a set of algorithms that substantially reduce the number of computations required to compute the discrete Fourier Transform (DFT). In the context of the Fast Fourier Transform (FFT), the term “coefficient” refers to the values obtained from the frequency-domain representation of a signal. After performing the FFT on a time-domain signal, the resulting complex spectrum consists of a set of coefficients that represent the amplitudes and phases of the sinusoidal components at different frequencies. Each coefficient in the FFT output corresponds to a specific frequency bin. The magnitude of the coefficient represents the amplitude or strength of the corresponding frequency component in the original signal, while the phase indicates the relative timing or position of that component. By analyzing the magnitudes and phases of the coefficients, various properties of the original signal can be determined. For example, the dominant frequency components, harmonic relationships, and overall spectral characteristics of the signal can be identified from the coefficients.

In the shown embodiment, a master musical composition 2000 is processed using a computer program. The master musical composition 2000 includes a multitrack audio recording and isolated master stems 3000. The isolated master stems 3000, when played together, form the master musical composition 2000. The master stems 3000 are shown as icons for the purpose of representing the mathematical coefficients of each stem. For representative purposes, the icons have different shapes and shades to represent differences in coefficients. Should the shapes and shades of two stems be identical, then the coefficients would be identical. Alternatively, the master musical composition 2000 and master stems are shown as waveforms.

During the FFT, the master musical composition 2000, typically represented as a waveform, is transformed from the time domain to the frequency domain. The master musical composition 2000 is typically stored on an audio file, such as a .wave file format. In one embodiment, the audio file is a MIDI file format, which includes a set of instructions for synthesizers, virtual instruments, or other MIDI-compatible devices to generate sound. These sinusoidal components, or “stems,” collectively represent the frequency content of the master audio file. The resulting FFT output provides a mathematical representation of the audio signal in terms of these stems or sinusoidal components. Each stem corresponds to a specific frequency present in the signal, and its amplitude and phase information contribute to the overall representation of the audio spectrum.

In one embodiment, the system for generating a unique identity for a musical composition comprises an electronic device having a processor and a memory, wherein the electronic device is adapted to read an audio file from an input device. The system includes an FFT (Fast Fourier Transform) engine, which serves as a fundamental component for performing the method described in this invention. The FFT engine is designed to efficiently compute the Fourier Transform of a master musical composition, the master stems, and a sample stem. The FFT engine comprises logic, that when executed by the processor causes the electronic device to process the master audio file to process the master audio file to generate a mathematical representation in the form of a master FFT, wherein the master audio file comprises one or more master stems. Moreover, the FFT engine is adapted to process each master stem of the one or more master stems to generate a mathematical representation in the form of a master stem FFT. Once processed, the FFT engine verifies the master audio file by associating each master stem FFT within the master FFT. The FFT engine is also adapted to compare the master stem with a sample via processing a sample audio file associated with a sample audio file to generate a mathematical representation in the form of a sample stem FFT and comparing the sample stem FFT against at least one of the master stems FFTs to determine degree of similarity based on a comparison of a coefficient of the sample stem FFT and a coefficient of the master stem FFT.

By executing the logic within the FFT engine, the electronic device performs these operations, enabling the generation of mathematical representations, verification of stem inclusion, and determination of the degree of similarity between the master stem and the sample stem. These functionalities contribute to the system's ability to provide a unique identity for a musical composition and its stems, facilitating tasks such as copyright verification, compositional lineage analysis, and quantification of similarity between compositions. In one embodiment, the system 1000 utilizes Python code as a programming language to implement the Fast Fourier Transform and related operations.

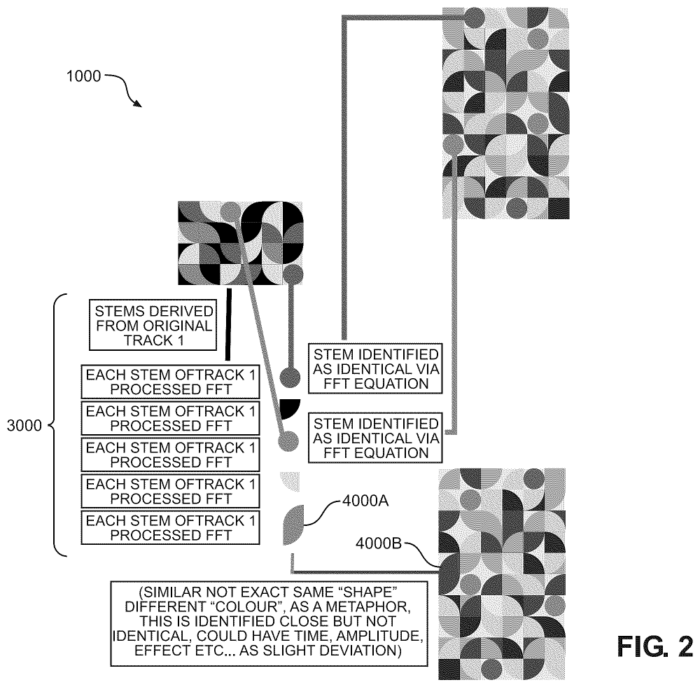

Referring now to FIG. 2, there is shown a diagram of verification of the master stem FFTs of the master audio file and identification of the degree of similarity of each of the master stem FFT with a sample stem FFT in accordance with one embodiment of the present invention. In the shown embodiment, the stem master FFT 3000 is being verified as a component of the master composition 2000. By comparing these master stem FFTs against the master, the system 1000 can determine whether each master stem is genuinely part of the master.

Once verified, the system 1000 compares at least one of the master stems FFTs with a sample stem FFT to determine degree of similarity based on a comparison of a coefficient of the master stem FFT and a coefficient of the sample stem FFT. For example, by using the mathematical representations of musical works, the system can identify potential similarities or overlaps between different compositions. Using a comparative analysis, the system can detect any instances where stems or complete compositions are reused or present in distinct musical works.

In the shown embodiment, the system has identified a master stem 4000A from the master that is similar to a sample stem 4000B in a sample composition. The system allows for the identification of phase shifts within stems, facilitating the comparison of a given sample stem with the master stems 3000. In one example, one of the sample stems is identical to the corresponding master stem, however it is phase shifted (time shifted) forward by 0.5 seconds. The system 1000 provides for manual or automated detection of the phase shift. By using this system and method, the comparison enables the quantification of the degree of similarity between the two stems 4000A, 4000B.

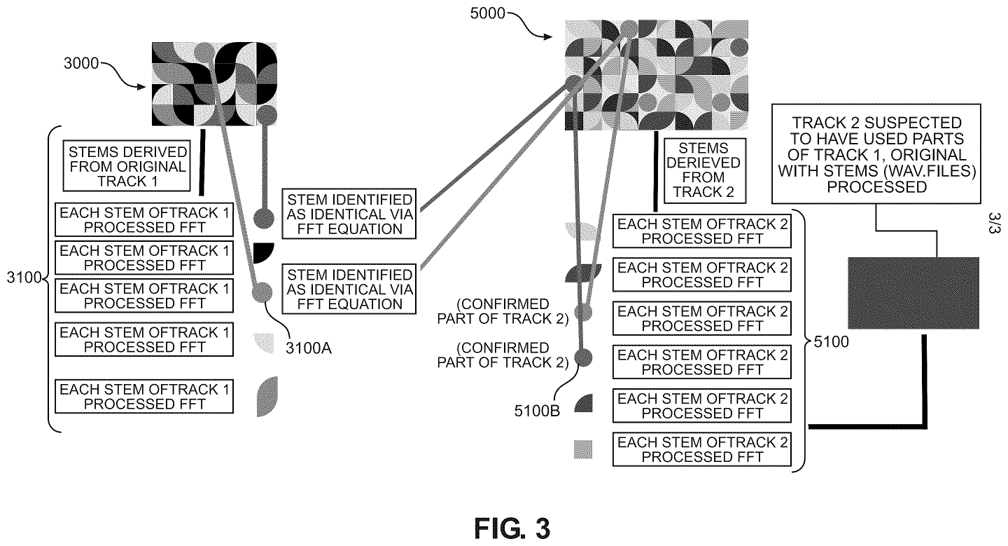

Referring now to FIG. 3, there is shown a diagram of a comparison of the FFT of the master stems with a FFT of the sample stems in accordance with one embodiment of the present invention. In the shown embodiment, a sample 5000 and associated sample stems 5100 are shown. The system 1000 compares each master stem 3100 from the master 3000 to the sample 5000 and associated sample stems 5100. This analysis involves comparing the mathematical representations, such as FFTs, of the master stems and sample stems and assessing the degree of similarity. The system shows that a verified master stem 3100A is identical to a sample stem 5100A from the sample 5000 using the FFT analysis.

When a match is found, it implies that the sample shares significant characteristics, elements, or patterns with the master. The matching can occur at different levels, such as at the composition level or stem level, depending on the scope of the comparison. The identification of a match between the master and sample can have several implications. For example, the similarity may have been a result of “sampling”. In music production, “sampling” involves using parts of pre-existing audio recordings in a new composition. When a match is found between the master and the sample, it can help identify instances of sampling and determine the extent to which the original work has been used. Additionally, a match between audio files (the master and sample) can also establish a creative lineage or connection between compositions or stems. It indicates that the sample audio file has similarities or shared elements with the master audio file, possibly implying influences, collaborations, or derivative works.

In one embodiment, the system and method are adapted to create a lineage of a musical composition and stems. The lineage of a musical composition and its associated stems refers to the process of establishing the historical origin and connections between different original compositions or stems. The lineage is created and used through the analysis of the mathematical representations generated by the FFT process. By analyzing the coefficients and other features of the representations, the system can determine if certain stems or components appear across multiple compositions. The established lineages can be further verified by cross-referencing existing databases or metadata associated with compositions and stems. This verification step ensures the accuracy and reliability of the lineage information. Moreover, the lineage assists composers, artists, and copyright holders understand the historical relationships between compositions and stems, providing insights into influences, collaborations, or derivative works. It can also aid in copyright protection by identifying possible infringements or unauthorized use of stems or compositions. The system is also adapted to display all other stems or compositions found to be related to the original composition. In one embodiment, the original composition is a registered copyrighted work.

In the context of music production, there are several common distortions that can be intentionally or unintentionally applied to alter the sound and create specific effects. This includes, but is not limited to overdrive, saturation, fuzz, bit crushing, flanging, chorus, phaser, tremolo, and reverb. When the musical composition is distorted, this affects the resulting FFT coefficient of the stems of the musical composition. In one embodiment, the system creates distorted FFTs. The set of distorted stem FFTs may be automatically generated from a set of common distortions. These can be compared with the master stems, sample stems, or other stems to determine the degree of similarity. In one embodiment, the master stem FFT includes a master set of distorted stem FFTs, wherein the master set of distorted stem FFTs are generated from a set of common distortions. By quantifying the differences between the distorted and original FFT coefficients, the system can assess the impact of the applied distortions and identify similarities or differences between the stems.

In one embodiment, the electronic device is adapted to correspond to any remote electronic device that is configured to communicate with (or facilitate communication with) one or more other wireless communication devices over a wireless communications system. The electronic device includes logic configured to receive and/or transmit information. If the communication device corresponds to a wireless communications device, the logic configured to receive and/or transmit information can include a wireless communications interface such as Bluetooth, Wi-Fi, Wi-Fi Direct, Long-Term Evolution (LTE) Direct, or other similar wireless protocols. This interface may consist of a wireless transceiver and associated hardware, such as an RF antenna, a MODEM, and a modulator/demodulator. Alternatively, the logic configured to receive and/or transmit information can correspond to a wired communications interface, such as a serial connection, a USB or Firewire connection, or an Ethernet connection through which the Internet can be accessed.

The electronic device further includes logic configured to process information. This processing logic typically includes a processor that enables various operations to be performed. Examples of processing tasks that can be carried out by the logic configured to process information include determinations, establishing connections, making selections between different information options, performing data evaluations, interacting with sensors connected to the communication device to conduct measurements, and converting information from one format to another (e.g., between different protocols such as .wav to .mp3, etc.). Additionally, the electronic device includes logic configured to store information. The storage logic comprises a non-transitory memory and associated hardware, such as a memory controller. The non-transitory memory can be any form of storage medium known in the art, including but not limited to non-transitory RAM, flash memory, ROM, erasable programmable ROM (EPROM), EEPROM, registers, hard disk, removable disk, CD-ROM, or any other suitable storage medium. The logic configured to store information may also encompass software that, when executed, enables the associated hardware to perform its storage function(s).

In one embodiment, a program comprises a comprehensive set of tools for music production, composition, and performance. The program displays time along the x-axis and isolates each stem within a row, showing the waveform of each stem, thereby displaying the arrangement of different audio and MIDI elements. The program is adapted to run the master and/or the master stems simultaneously with the sample and/or sample stem after the Fast Fourier Transform operation and reverse phase. When the reverse phase function runs, if the master stem and sample stem are identical, it results in no audio as the stems canceled each other. If the sample stem is phase-shifted or distorted, then the reverse phase function may partially cancel the stem, indicating some degree of similarity. The system or the user may automatically adjust the sample to result in the maximum cancelation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method for generating a unique identity for a musical composition, comprising:
processing a master audio file associated with a musical composition to generate a mathematical representation in the form of a master FFT;
wherein the master audio file comprises one or more master stems;
processing each master stem of the one or more master stems to generate a mathematical representation in the form of a master stem FFT;
verifying the master audio file by associating each master stem FFT within the master FFT;
processing a sample audio file associated with a sample audio file to generate a mathematical representation in the form of a sample stem FFT;
comparing the sample stem FFT against at least one of the master stems FFTs to determine degree of similarity based on a comparison of a coefficient of the sample stem FFT and a coefficient of the master stem FFT.

2. The method of claim 1, wherein the audio file is a .wav file.

3. The method of claim 2, wherein the master stem FFT is generated via Python Script.

4. The method of claim 3, wherein the sample stem FFT is generated via Python Script.

5. The method of claim 1, further comprising:
establishing a compositional lineage via associated one or more of the master stems with an original composition via analysis of the coefficient of the master stem FFT.

6. The method of claim 1, further comprising:
establishing a compositional lineage via association of a collection of the one or more of the master stems with an original composition via analysis of the coefficient of the master stem FFT.

7. The method of claim 1, further comprising:
generating of a set of distorted stem FFTs for each sample stem FFT, wherein the set of distorted stem FFTs are generated from a set of common distortions.

8. The method of claim 7, wherein the master stem FFT includes a master set of distorted stem FFTs, wherein the master set of distorted stem FFTs are generated from a set of common distortions.

9. The method of claim 8, further comprising:
comparing the set of distorted stem FFTs to the master set of distorted stem FFTs to determine degree of similarity.

10. The method of claim 1, further comprising:
generating a report of a comparative analysis of at least one of the sample stems FFTs with the master stem FFT.

11. A system for generating a unique identity for a musical composition, the system comprising:
an electronic device having a processor and a memory, wherein the electronic device is adapted to read an audio file from an input device;
wherein the audio file is a master audio file;
an FFT engine having logic, that when executed by the processor causes the electronic device to:
process the master audio file to generate a mathematical representation in the form of a master FFT;
wherein the master audio file comprises one or more master stems;
process each master stem of the one or more master stems to generate a mathematical representation in the form of a master stem FFT;
verify the master audio file by associating each master stem FFT within the master FFT;
process a sample audio file associated with a sample audio file to generate a mathematical representation in the form of a sample stem FFT;
compare the sample stem FFT against at least one of the master stems FFTs to determine degree of similarity based on a comparison of a coefficient of the sample stem FFT and a coefficient of the master stem FFT.

12. The system of claim 11, wherein the input device is selected from the following: DVDs, CDs, hard disk drives, magnetic tape, cloud storage, digital audio files, and servers for streaming media over networks.

13. The system of claim 11, wherein the sample is stored on non-transitory medium.

14. The system of claim 11, wherein the electronic device is adapted to correspond to any remote electronic device that is configured to communicate with one or more other wireless communication devices over a wireless communications system.

15. The system of claim 11, wherein the audio file is a “.wave” file.

16. The system of claim 11, wherein the master stem FFT is generated via Python Script.

17. The system of claim 16, wherein the sample stem FFT is generated via Python Script.

18. The system of claim 11, wherein the FFT engine is further adapted to establish a compositional lineage via associated one or more of the master stems with an original composition via analysis of the coefficient of the master stem FFT.

19. The system of claim 11, wherein the FFT engine is further adapted to:
establish a compositional lineage via association of a collection of the one or more of the master stems with an original composition via analysis of the coefficient of the master stem FFT.

20. The system of claim 1, wherein the FFT engine is further adapted to:
generate a set of distorted stem FFTs for each sample stem FFT, wherein the set of distorted stem FFTs are generated from a set of common distortions.
